(19) United States
(12) Patent Application Publication
(10) Pub. No.: US 2017/0292293 A1
(43) Pub. Date: Oct. 12, 2017

(54) DOOR LATCH ASSEMBLY

(71) Applicant: Hung Chin Architectrual Hardware Co., Taipei (TW)

(72) Inventor: Wei Chun LIN, Taipei (TW)

(21) Appl. No.: 15/092,891

(22) Filed: Apr. 7, 2016

(51) Int. Cl. E05B 65/10; E05C 9/24; E05C 3/16; E05C 9/04

(52) U.S. Cl. CPC E05B 65/1006; E05B 65/1053; E05C 9/046; E05C 9/24; E05C 3/16

(57) ABSTRACT

A door latch assembly includes two receptacles and latchbolts mounted to a door panel, two actuating levers connected to the latchbolts, a base support attached the door panel, a sliding member slidably attached to the base support, two cranks attached to the base support and engaged with the sliding member, two couplers attached to the base support and coupled to the cranks, two seats attached to the couplers, and two adjusting devices each include one end threaded with the seat and another end threaded with the actuating lever and for allowing the actuating levers to be moved and adjusted relative to the seats with the adjusting device.

### BACKGROUND OF THE INVENTION

### 1. Field of the Invention

The present invention relates to a door latch assembly for a panic exit door, and more particularly to a door latch assembly for a panic exit door including an improved and simplified structure or configuration for allowing the door latch assembly to be easily and quickly made or manufactured with a reduced making or manufacturing procedure and/or cost and to be easily and quickly adjusted and assembled by the workers or the like.

### 2. Description of the Prior Art

Various kinds of typical door latch assemblies for panic exit doors have been developed and provided for latching or locking the exit doors and comprise a push bar connected or coupled to a door latch assembly for actuating or operating the door latch assembly to lock and release the exit doors.

For example, U.S. Pat. No. 5,464,259 to Cohrs et al., U.S. Pat. No. 6,009,732 to Haeck et al., and U.S. Patent Application Publication No. 2012/0032455 A1 to Lin disclose several of the typical door latch assemblies for panic exit doors and each also comprising a door latch assembly including an upper latch device and a lower latch device for selectively latching or locking an exit door panel to a door frame, and a push bar connected or coupled to the upper latch device and the lower latch device of the door latch assembly for actuating or operating the door latch assembly to lock and release the exit doors.

However, the upper and the lower latch devices of the door latch assembly should be actuated or operated by a complicated connecting or coupling mechanism, in addition, the upper and the lower latch devices of the door latch assembly also include a complicated connecting or coupling mechanism and may not be easily adjusted and attached to the door panels and/or the door frames of different standards or sizes or dimensions.

The present invention has arisen to mitigate and/or obviate the afore-described disadvantages of the conventional door latch assemblies.

### SUMMARY OF THE INVENTION

The primary objective of the present invention is to provide a door latch assembly including an improved and simplified structure or configuration for allowing the door latch assembly to be easily and quickly assembled by the workers and for allowing the door latch assembly to be easily and quickly made or manufactured with a reduced making or manufacturing procedure and/or cost and to be easily and quickly adjusted and assembled by the workers or the like.

In accordance with one aspect of the invention, there is provided a door latch assembly comprising a door panel, two receptacles mounted to the door panel and spaced from each other, two latchbolts pivotally attached to the receptacles respectively, two actuating levers connected to the latchbolts for pivoting the latchbolts relative to the receptacles respectively, and the actuating levers each including an engaging hole formed therein, a base support attached the door panel, a sliding member slidably attached to the base support, and the sliding member including a slot formed therein, a push bar attached to the door panel and connected to the push bar for moving the sliding member relative to the base support selectively, two cranks rotatably attached to the base support, and each crank including an eccentric rod engaged with the slot of the sliding member for allowing the cranks to be rotated relative to the base support with the sliding member when the sliding member is moved relative to the base support, an actuating device including two couplers slidably attached to the base support and coupled to the cranks for allowing the couplers to be moved relative to the base support and the latchbolts by the cranks and the sliding member, two bars slidably attached to the base support and secured to the couplers for allowing the bars and the couplers to be moved in concert with each other relative to the base support, two seats attached to the bars respectively, and the seats each including an engaging hole formed therein, and two adjusting devices each including a first end portion for threadedly engaging with the engaging hole of the seat respectively, and a second end portion for threadedly engaging with the engaging hole of the actuating lever respectively and for allowing the actuating levers to be moved and adjusted relative to the seats with the adjusting device and for allowing the parts or elements to be suitably mounted to the door panel without cutting or adjusting the lengths of the parts or elements.

The actuating device includes two brackets attached to the base support for slidably engaging with the couplers. The brackets each include two flaps, and a passage formed in the flaps for slidably engaging with a guide rod, and the couplers are mounted to the guide rods and movable relative to the brackets. The actuating device includes two bars slidably engaged with the base support and attached to the couplers respectively.

The adjusting devices each include a plurality of orifices formed therein for engaging with a driving tool. The actuating device includes a fastener engaged with one of the seats for selectively engaging into the engaging hole of the seat and for selectively engaging with the adjusting device and for securing the adjusting device to the seat.

The cranks each include an eccentric shaft attached thereto and slidably connected to the coupler for allowing the coupler to be moved relative to the bracket and the base support with the crank and the sliding member. The sliding member includes at least one oblong hole formed therein, and the base support includes a cover attached to the base support, and at least one pin attached to the cover and slidably engaged with the at least one oblong hole of the sliding member for guiding and limiting the sliding member to move relative to the base support.

The base support includes an operating member rotatably attached to the base support with a pivot pole, and includes a non-circular engaging hole formed in the operating member and formed through the pivot pole. The operating member includes two eccentric projections extended therefrom for engaging with the sliding member and for moving the sliding member relative to the base support.

A handle device may further be provided and includes a housing attached to the door panel, and a mandrel extended from the housing and engaged with the engaging hole of the operating member, and a hand grip coupled to the mandrel.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of a latch mechanism of a door latch assembly for a panic exit door in accordance with the present invention;

FIG. 2 is a partial perspective view of the latch mechanism for the door latch assembly;

FIG. 3 is another partial perspective view of the latch mechanism for the door latch assembly as seen from the other angle or direction of the latch mechanism;

FIG. 4 is a partial exploded view of the latch mechanism for the door latch assembly;

FIG. 5 is an enlarged partial perspective view of the latch mechanism for the door latch assembly;

FIGS. 6, 7 are enlarged partial exploded views of the latch mechanism for the door latch assembly;

FIG. 8 is another partial exploded view of the latch mechanism for the door latch assembly;

FIG. 9 is a further partial exploded view of the latch mechanism for the door latch assembly; and

FIGS. 10 and 11 are enlarged partial perspective views similar to FIG. 5, illustrating the operation of the latch mechanism for the door latch assembly.

### DETAILED DESCRIPTION OF THE PREFERRED EMBODIMENT

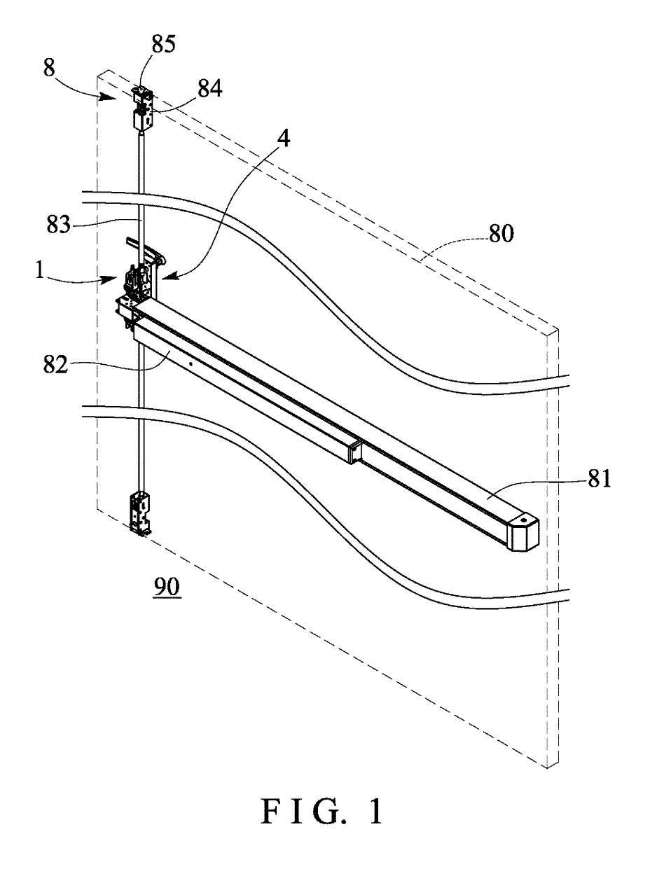

Referring to the drawings, and initially to FIGS. 1-4, a door latch assembly in accordance with the present invention comprises a latch mechanism including one or more (such as two) transmitting or latch devices 8 disposed or engaged into a door panel 80, such as an exit door panel 80 that is disposed or engaged into a door frame (not illustrated), and preferably arranged or located at one side or edge portion of the door panel 80 (FIG. 1), and mounted or secured to the door panel 80 with screws or catches or fasteners (not illustrated) or the like, and as shown in FIG. 1, the door panel 80 includes a box or casing 81 attached or mounted to the inner or indoor portion of the door panel 80, and a push bar 82 slidably attached or mounted to the casing 81 and connected or coupled to the latch devices 8 with one or more (such as two) actuating levers 83 for selectively actuating or operating the actuating levers 83 to actuate or operate the latch devices 8 of the latch mechanism.

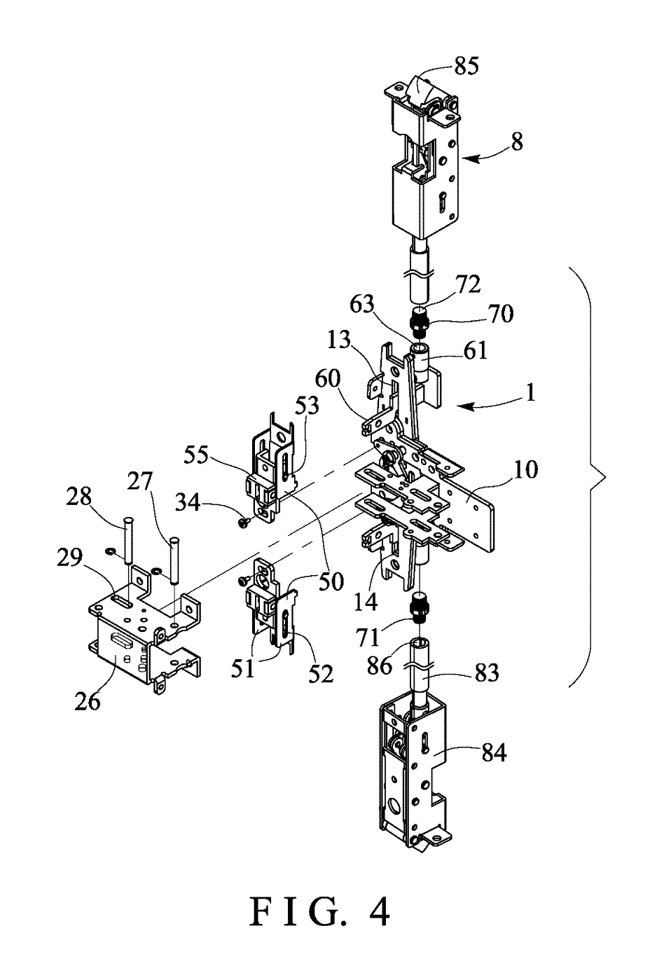

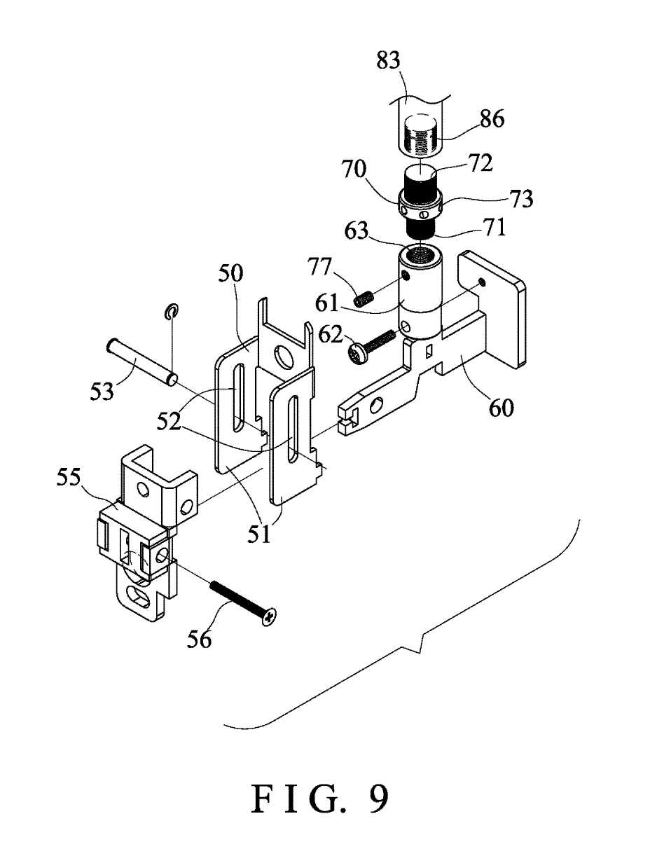

One or more (such as two) strikes (not illustrated) are disposed or engaged into the door frame and/or a floor 90 (FIG. 1), and the latch devices 8 of the latch mechanism each include a housing or receptacle 84 attached or mounted to the inner or indoor portion of the door panel 80 with screws or catches or fasteners (not illustrated) or the like, and each include an actuating element or tongue or latchbolt 85 pivotally or rotatably attached or mounted to the receptacle 84 and connected or coupled to or engaged with the actuating levers 83 for allowing the latchbolt 85 to be actuated and moved relative to the receptacle 84 by the push bar 82 with the actuating levers 83 selectively. The above-described structure or configuration for the push bar 82 and the actuating levers 83 and the latchbolt 85 of the latch devices 8 of the latch mechanism is typical and is not related to the present invention and will not be described in further details. The actuating levers 83 each include a threaded engaging hole 86 formed in the free end portion thereof (FIGS. 4, 9) for threadedly engaging with an adjusting device 70.

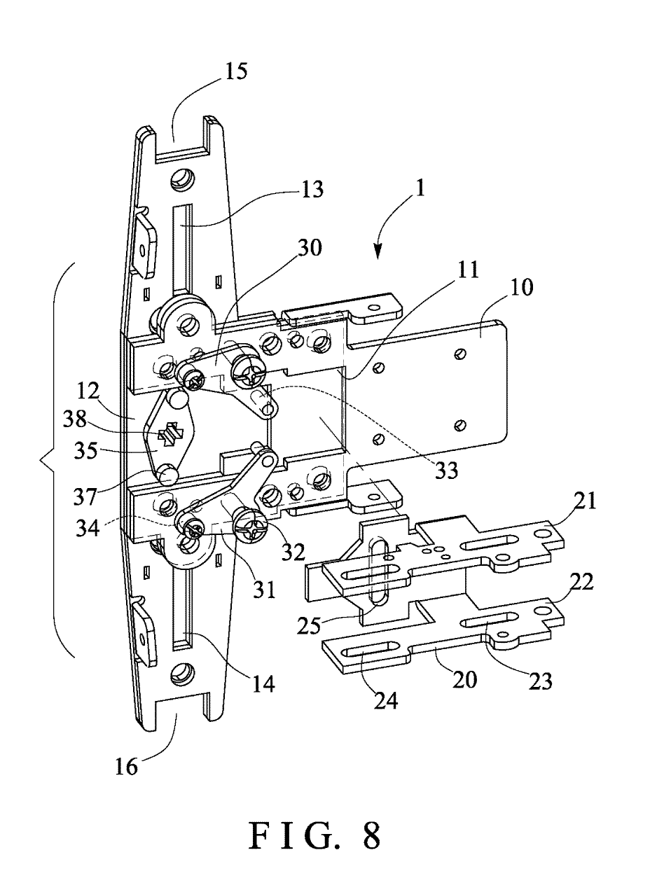

The latch mechanism includes an actuating device 1 attached or mounted or secured to the door panel 80 and engaged with or connected or coupled between the actuating levers 83 and the push bar 82 for allowing the latchbolts 85 of the latch devices 8 to be actuated or operated by the actuating device 1 with the push bar 82. For example, the actuating device 1 includes a casing or frame or base plate or support 10 attached or mounted or secured to the door panel 80 with screws or catches or fasteners (not illustrated) or the like, and as shown in FIG. 8, the base support 10 includes a slot or recess or channel 11 formed therein for slidably receiving or engaging with a follower or sliding member 20 and arranged for allowing the sliding member 20 to be moved laterally along or relative to the base support 10, the sliding member 20 is connected or coupled to the push bar 82 for being actuated or moved laterally relative to the base support 10 with or by the push bar 82 selectively.

The base support 10 further includes a recess or depression 12 formed therein and communicating with the channel 11 of the base support 10, and further includes two oblong holes or grooves 13, 14 oppositely formed therein and aligned with or in line with each other, best shown in FIG. 8, and further includes two recesses or notches 15, 16 oppositely formed therein and located at the upper and the lower portions of the base support 10 and located farther and outer than the grooves 13, 14 of the base support 10. The sliding member 20 includes one or more (such as two) flaps or panels 21, 22 extended therefrom and parallel to each other, and includes two grooves or oblong holes 23, 24 formed in each of the panels 21, 22, and further includes a channel or slot 25 formed therein and perpendicular to the oblong holes 23, 24 of the panels 21, 22. A hood or cover 26 is attached or mounted or secured to the base support 10 with screws or catches or fasteners (not illustrated) or the like for shielding or covering or protecting the sliding member 20.

For example, the cover 26 includes one or more (such as two) shafts or pins 27, 28 attached or mounted or secured to the cover 26, and slidably received or engaged in the oblong holes 23, 24 of the panels 21, 22 of the sliding member 20; or one of the pins 27 is secured to the cover 26 and slidably engaged in the oblong holes 23 of the panels 21, 22 of the sliding member 20, for guiding or limiting the sliding member 20 to slide or move laterally relative to the base support 10 and for solidly and stably anchoring or retaining or positioning the sliding member 20 to the base support 10 and for preventing the sliding member 20 from being disengaged or separated from the base support 10. The cover 26 may further include another groove or oblong hole 29 formed therein for slidably receiving or engaging with the other pin 28; or the other pin 28 is secured to the sliding member 20 and slidably engaged in the oblong holes 29 of the cover 26, for further guiding or limiting the sliding member 20 to slide or move laterally relative to the base support 10.

Two elbows or cranks 30, 31 are each pivotally or rotatably attached or mounted or secured to the base support 10 with a pivot pin or axle 32 for allowing the cranks 30, 31 to be pivoted or rotated relative to the base support 10 with the pivot axle 32, and each include an eccentric stud or rod 33 attached thereto or extended therefrom and slidably received or engaged in the slot 25 of the sliding member 20 for allowing the cranks 30, 31 to be pivoted or rotated relative to the base support 10 with or by the sliding member 20 when the sliding member 20 is slid or moved laterally relative to the base support 10. The cranks 30, 31 each further include an eccentric rod or shaft 34 attached thereto or extended therefrom and spaced or separated from the respective eccentric rod 33.

An operating device or member 35 is pivotally or rotatably attached or mounted or secured to the base support 10 with a pivot pole 36 (FIG. 3) and received or engaged in the depression 12 of the base support 10, and includes a non-circular engaging hole 38 formed in the operating member 35 and/or formed through the pivot pole 36, and includes two eccentric tongues or projections 37 extended therefrom for selectively contacting or engaging with the sliding member 20 and for selectively moving the sliding member 20 laterally relative to the base support 10 when the operating member 35 is pivoted or rotated relative to the base support 10 with an outdoor handle device 4. The engagement or attachment of the operating member 35 with the sliding member 20 is also typical and is not related to the present invention and will not be described in further details.

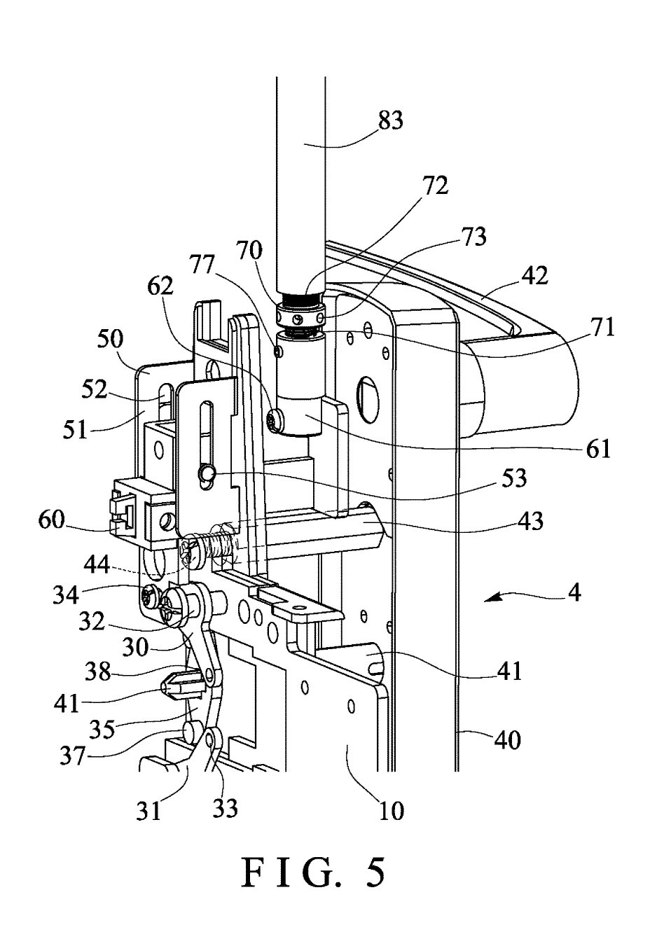

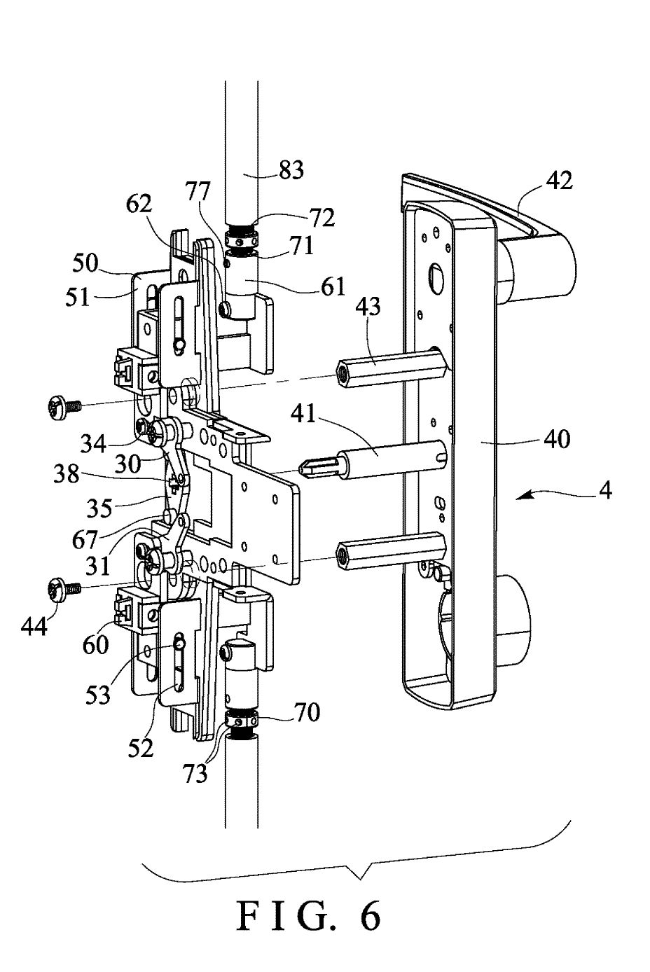

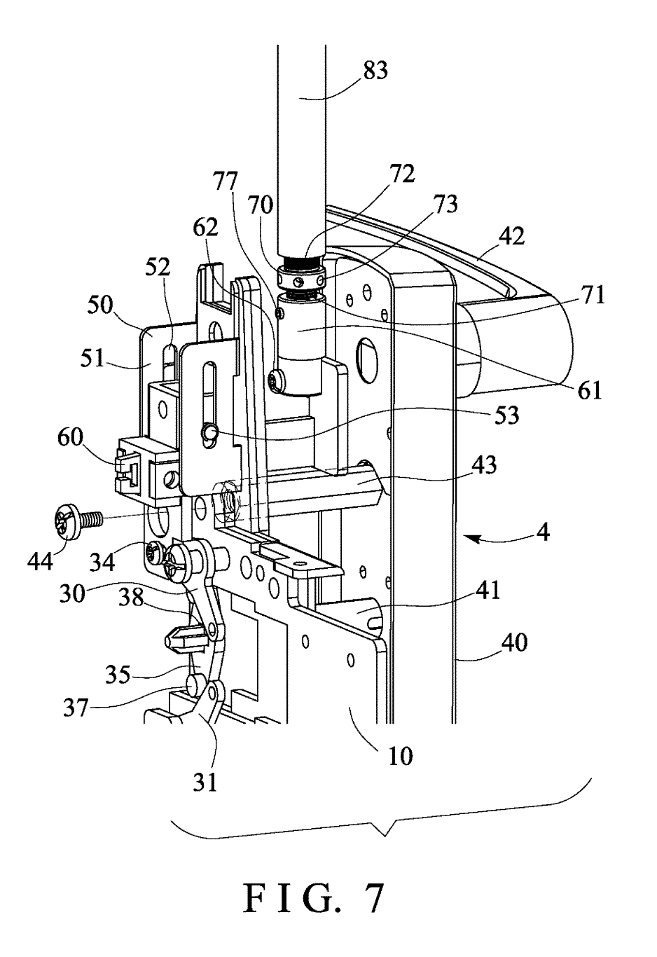

For example, the outdoor handle device 4 includes a housing 40 attached or mounted or secured to the outside of the door panel 80, and a spindle or mandrel 41 extended from the housing 40 and engaged with the non-circular engaging hole 38 of the operating member 35, and a hand grip 42 pivotally or rotatably attached or mounted or secured to the housing 40 and connected or coupled to the mandrel 41 for pivoting or rotating the mandrel 41 relative to the housing 40 and thus for allowing the operating member 35 to be selectively pivoted or rotated relative to the base support 10 with the mandrel 41 and the hand grip 42 of the outdoor handle device 4, in order to move the sliding member 20 laterally relative to the base support 10 selectively. The outdoor handle device 4 further includes one or more (such as two) guide posts or shanks 43 extended from the housing 40 and secured to the base support 10 with screws or catches or fasteners 44 (FIGS. 5-7) or the like. The engagement or attachment of the hand grip 42 with the mandrel 41 is also typical and is not related to the present invention and will not be described in further details.

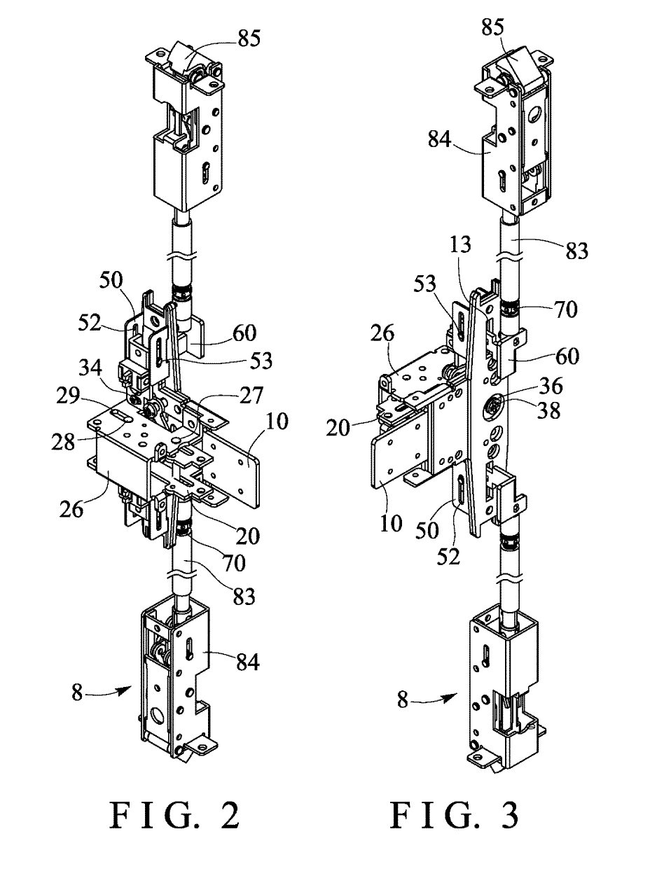

The actuating device 1 further includes two brackets 50 attached or mounted or secured to the base support 10 (FIGS. 2-7 and 9-11) with screws or catches or fasteners (not illustrated) or the like, and the brackets 50 each include one or more (such as two) panels or flaps 51 extended therefrom (FIG. 9) and parallel to each other, and each include an oblong hole or passage 52 formed in each of the flaps 51 for slidably receiving or engaging with a guide rod 53, and two couplers 55 are attached or mounted to the guide rod 53 and slidably attached to or engaged with the brackets 50 or the base support 10 by the sliding engagement of the guide rod 53 with the passages 52 of the flaps 51 of the bracket 50. The shafts 34 of the cranks 30, 31 are slidably connected or coupled to the couplers 55 (FIGS. 5-7, 10-11) for allowing the couplers 55 to be actuated and moved up and down relative to the brackets 50 and the base support 10 and the latchbolts 85 and the receptacles 84 with or by the cranks 30, 31 and the sliding member 20.

Two levers or links or bars 60 are slidably engaged with the grooves 13, 14 of the base support 10 respectively (FIGS. 2-4), and attached or mounted or secured to the couplers 55 with screws or catches or fasteners 56 (FIG. 9) or the like for allowing the bars 60 to be moved up and down relative to the brackets 50 and the base support 10 together with the couplers 55. Two bases or sockets or seats 61 are attached or mounted or secured to the bars 60 with screws or catches or fasteners 62 (FIGS. 5-7 and 9) or the like respectively, and the seats 61 each include a threaded engaging hole 63 formed in the free end portion thereof (FIGS. 4, 9) for threadedly engaging with the adjusting device 70. The adjusting device 70 includes a substantially cylindrical and threaded structure or configuration having one or first end or inner portion 71 for threadedly engaging with the engaging hole 63 of the seat 61 and having another or second end or outer portion 72 for threadedly engaging with the engaging hole 86 of the actuating lever 83.

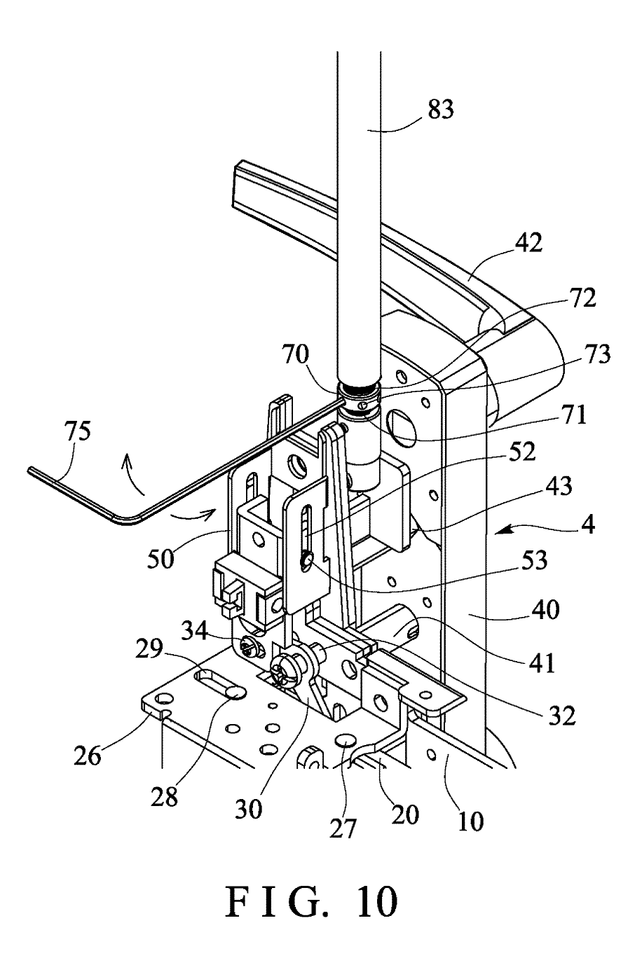

In operation, the actuating levers 83 may be actuated or operated or moved up and down toward or away from the brackets 50 and the base support 10 when the adjusting device 70 are pivoted or rotated relative to the actuating levers 83 and the seats 61 respectively, for adjusting distance between the latchbolts 85 and the receptacles 84, and thus for allowing the latchbolts 85 and the receptacles 84 and the couplers 55 of the actuating device 1 to be suitably attached or mounted or secured to the door panels 80 of different standards or sizes or dimensions, without cutting or adjusting the lengths of the parts or elements, such as the actuating levers 83. The adjusting devices 70 each include a number of orifices 73 formed therein and faced or directed laterally and radially and outwardly relative to the adjusting devices 70 for selectively engaging with the driving tool 75 (FIG. 10) which may pivot or rotate the adjusting devices 70 relative to the actuating levers 83 and the seats 61.

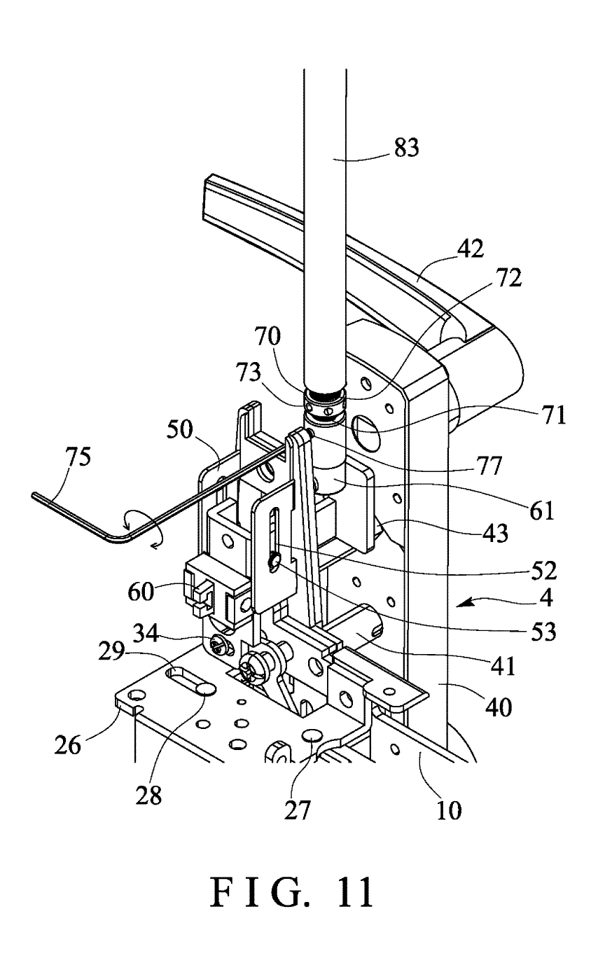

As shown in FIGS. 9 and 11, anther screw or fastener 77 may further be provided and threaded or engaged with the respective seat 61 for selectively engaging into the engaging hole 63 of the seat 61 and for selectively engaging with the respective adjusting device 70 and thus for selectively mounting or securing or retaining the adjusting device 70 to the actuating lever 83 and the seat 61 respectively, and for preventing the adjusting device 70 from being further pivoted or rotated relative to the actuating lever 83 and the seat 61, after the actuating lever 83 has been suitably adjusted relative to the seat 61. The driving tool 75 may also be used to engage with and to pivot or rotate or drive the fastener 77 relative to the seat 61 (FIG. 11). Similarly or alternatively, the fastener 77 may also be used to engage with the actuating lever 83 and to secure the adjusting device 70 to the actuating lever 83 selectively.

In operation, as shown in FIGS. 1-4, the base support 10 may first be attached or mounted or secured to the middle or intermediate portion of the door panel 80, and the actuating levers 83 may then be adjusted and moved relative to the seats 61 for allowing the latchbolts 85 and the receptacles 84 to be suitably attached or mounted or secured to the upper and the lower or bottom portion of the door panel 80 without cutting or adjusting the lengths of the parts or elements, such as the actuating levers 83. As shown in FIG. 10, the driving tool 75 may be engaged with either of the orifices 73 of the adjusting device 70 to rotate or drive the adjusting device 70 relative to the actuating levers 83 and the seats 61, and may also be used to engage with the fastener 77 for rotating or driving the fastener 77 relative to the seat 61 (FIG. 11).

Accordingly, the door latch assembly in accordance with the present invention includes an improved and simplified structure or configuration for allowing the door latch assembly to be easily and quickly made or manufactured with a reduced making or manufacturing procedure and/or cost and to be easily and quickly adjusted and assembled by the workers or the like.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A door latch assembly comprising:
a door panel,
two receptacles mounted to said door panel and spaced from each other,
two latchbolts pivotally attached to said receptacles respectively,
two actuating levers connected to said latchbolts for pivoting said latchbolts relative to said receptacles respectively, and said actuating levers each including an engaging hole formed therein,
a base support attached said door panel,
a sliding member slidably attached to said base support, and said sliding member including a slot formed therein,
a push bar attached to said door panel and connected to said push bar for moving said sliding member relative to said base support selectively,
two cranks rotatably attached to said base support, and each crank including an eccentric rod engaged with said slot of said sliding member for allowing said cranks to be rotated relative to said base support with said sliding member when said sliding member is moved relative to said base support,
an actuating device including:
two couplers slidably attached to said base support and coupled to said cranks for allowing said couplers to be moved relative to said base support and said latchbolts by said cranks and said sliding member,
two bars slidably attached to said base support and secured to said couplers for allowing said bars and said couplers to be moved in concert with each other relative to said base support,
two seats attached to said bars respectively, and said seats each including an engaging hole formed therein, and
two adjusting devices each including a first end portion for threadedly engaging with said engaging hole of said seat respectively, and a second end portion for threadedly engaging with said engaging hole of said actuating lever respectively and for allowing said actuating levers to be moved and adjusted relative to said seats with said adjusting device.

2. The door latch assembly as claimed in claim 1, wherein said actuating device includes two brackets attached to said base support for slidably engaging with and for supporting said couplers.

3. The door latch assembly as claimed in claim 2, wherein said brackets each include two flaps extended therefrom and parallel to each other, and each include a passage formed in said flaps for slidably engaging with a guide rod, and said couplers are mounted to said guide rods respectively.

4. The door latch assembly as claimed in claim 2, wherein said actuating device includes two bars slidably engaged with said base support and attached to said couplers respectively.

5. The door latch assembly as claimed in claim 1, wherein said adjusting devices each include a plurality of orifices formed therein for engaging with a driving tool.

6. The door latch assembly as claimed in claim 1, wherein said actuating device includes a fastener engaged with one of said seats for selectively engaging into said engaging hole of said seat and for selectively engaging with said adjusting device and for securing said adjusting device to said seat.

7. The door latch assembly as claimed in claim 1, wherein said cranks each include an eccentric shaft attached thereto and slidably connected to said coupler for allowing said coupler to be moved relative to said bracket and said base support with said crank and said sliding member.

8. The door latch assembly as claimed in claim 1, wherein said sliding member includes at least one oblong hole formed therein, and said base support includes a cover attached to said base support, and at least one pin attached to said cover and slidably engaged with said at least one oblong hole of said sliding member for guiding and limiting said sliding member to move relative to said base support.

9. The door latch assembly as claimed in claim 1, wherein said base support includes an operating member rotatably attached to said base support with a pivot pole, and includes a non-circular engaging hole formed in said operating member and formed through said pivot pole.

10. The door latch assembly as claimed in claim 9, wherein said operating member includes two eccentric projections extended therefrom for engaging with said sliding member and for moving said sliding member relative to said base support.

11. The door latch assembly as claimed in claim 9, wherein a handle device includes a housing attached to said door panel, and a mandrel extended from said housing and engaged with said engaging hole of said operating member, and a hand grip coupled to said mandrel.
